(19) United States
(12) Patent Application Publication
(10) Pub. No.: US 2012/0166309 A1
(43) Pub. Date: Jun. 28, 2012

(54) AUTHENTICATION SYSTEM AND AUTHENTICATION METHOD USING BARCODES

(75) Inventors: Jung Yeon HWANG, Gyeonggi-do (KR); Sokjoon Lee, Daejeon (KR); Gun Tae Bae, Daejeon (KR); Byung Ho Chung, Daejeon (KR); Sin Hyo Kim, Daejeon (KR); Yun-Kyung Lee, Daejeon (KR); Sang-Woo Lee, Daejeon (KR); Hyeran Mun, Gyeonggi-do (KR); Hyun Sook Cho, Daejeon (KR)

(73) Assignee: Electronics and Telecommunications Research Institute, Daejeon (KR)

(21) Appl. No.: 13/337,802

(22) Filed: Dec. 27, 2011

(30) Foreign Application Priority Data
Dec. 27, 2010 (KR) 10-2010-0136096
Dec. 14, 2011 (KR) 10-2011-0134807

(51) Int. Cl. G06Q 30/06; G06K 5/00

(52) U.S. Cl. 705/26.41; 235/375

(57) ABSTRACT

Disclosed is an authentication method using barcodes. the authentication method includes: converting into a first barcode and outputting, by a first user device, authentication related information provided from a service providing server; receiving, by a second user device, the first barcode; generating, by the second user device, signature information or authentication information on the authentication related information by using a signature key or a certificate; and providing, by the second user device, the signature information or the authentication information to the service providing server.

### CROSS-REFERENCES TO RELATED APPLICATIONS

The present application claims priority under 35 U.S.C 119(a) to Korean Application No. 10-2010-0136096, filed on Dec. 27, 2010, and Korean Application No. 10-2011-0134807, filed on Dec. 14, 2011, in the Korean Intellectual Property Office, which is incorporated herein by reference in its entirety set forth in full.

### BACKGROUND

Exemplary embodiments relate to an authentication system and an authentication method using bar codes, and more particularly, to an authentication system and an authentication method using bar codes capable of performing user authentication through bar codes or a separate communication network in personal terminal devices such as a smart phone, a mobile phone, or the like, are provided.

A certificate, which is electronic information issued by a certificate authority (CA) for the purpose of verifying identity and preventing forgery and alternation of a document, repudiation of transaction, or the like, when performing e-commerce, is a kind of seal certificate for cyber trading.

A user or a message may be authenticated through an electronic signature based on an official certificate or a private certificate. The authentication method is greatly used in the Internet financial sector, but is diversely used for stock transaction, e-commerce, administrative service, or the like.

Generally, the certificate includes a public key of a user (or user related information) and a signature of a trusted third party, that is, the certificate authority (CA), verifying that the public key belongs to a specific user.

When the user generates signature information on a specific message by using a signature key corresponding to his/her own public key, a verifier can use the public key of the user to verify validity of the given signature information.

Here, the signature key is information known to only the user, which is on the grounds that the user cannot deny the fact that worthwhile services are provided to the user.

Further, in addition to the traditional public key infrastructure certificate that is prevalently being used today, it is expected that certificates for various purposes, such as a device certificate for Voice Over Internet Protocol (VoIP), an anonymous certificate for anonymous authentication, or the like, and authentication method corresponding thereto are used in various applications.

Meanwhile, the certificate infrastructure electronic signature method has many advantages, but causes a problem of management for certificates in recent years.

That is, the users frequently store the certificates in a hard disk of a computer for convenience of use. As such, when storing the certificates in a hard disk, since the computer is vulnerable to various types of security threats such as computer hacking, or the like, the signature key information may be easily leaked to the outside.

Therefore, in order to solve the problem, a public institution, or the like, has recommended that users use certain methods for storing and using a certificate and a signature key in a portable storage medium. However, the method for storing a certificate and a signature key in a separate portable storage medium is troublesome for users and the portable storage medium may be lost. Therefore, the method for storing a certificate and a signature key cannot contribute to a fundamental solution.

Background art of the present invention is disclosed in the Korean Patent Laid-Open Publication No. 10-2003-0035025 entitled “System for providing identification service using official certificate based on public key infrastructure and method thereof”.

### SUMMARY

An embodiment of the present invention is directed to an authentication system and an authentication method using the bar codes capable of performing safely and conveniently user authentication using personal terminal devices are provided.

An embodiment of the present invention relates to an authentication method using barcodes, including: converting into a first barcode and outputting, by a first user device, authentication related information provided from a service providing server; receiving, by a second user device, the first barcode; generating, by the second user device, signature information or authentication information on the authentication related information by using a signature key or a certificate; and providing, by the second user device, the signature information or the authentication information to the service providing server.

In one embodiment, at the providing of the signature information or the authentication to the service providing server, the second user device may provide the signature information or the authentication information to the service providing server through the first user device.

In one embodiment, the providing of the signature information or the authentication information to the service providing server may include: converting into a second barcode and outputting, by the second user device, the signature information or the authentication information; receiving, by the first user device, the second barcode for the signature information or the authentication information; and transmitting, by the first user device, the signature information or the authentication information to the service providing server.

In one embodiment, at the providing of the signature information or the authentication information to the service providing server, the second user device may transmit the signature information or the authentication information to the service providing server through a wireless communication network.

Another embodiment of the present invention relates to an authentication method using barcodes, including: receiving, by a first user device, at least one purchase information selected by a user in a purchase information list from a service providing server, and converting into at least one barcode and outputting the at least one purchase information; receiving, by a second user device, the at least one barcode to receive the at least one purchase information; generating, by the second user device, signature information or authentication information on the at least one purchase information by using a signature key or a certificate; and providing, by the second user device, the signature information or the authentication information to a payment service providing server for providing a payment service.

In another embodiment, at the generating of the signature information or the authentication information, the second user device may generate the signature information or the authentication information for a part or all of the plurality of purchase information.

In another embodiment, the plurality of purchase information may be provided from a plurality of different services providing servers.

In another embodiment, at the providing of the signature information or the authentication information to the payment service providing server, the second user device may provide the signature information or the authentication information to the payment service providing server through the first user device.

In another embodiment, the providing of the signature information or the authentication information to the payment service providing server may include: converting into a second barcode and outputting, by the second user device, the signature information or the authentication information; receiving, by the first user device, the second barcode for the signature information or the authentication information; and transmitting, by the first user device, the signature information or the authentication information to the payment service providing server.

Another embodiment of the present invention relates to an authentication system using barcodes including: a service providing server configured to provide service to be authenticated by a user; a first user device configured to convert into the barcodes and output information provided from the service providing server; and a second user device configured to receive the barcodes output from the first user device, generate signature information or authentication information by using a signature key or a certification, and provide the signature information or the authentication information to the service providing server.

In another embodiment, the authentication system further includes a payment service providing server configured to receive the signature information or the authentication information from the second user device to provide a payment service for the service provided from the service providing server.

In another embodiment, the service provided from the service providing server may be any one of an Internet banking service, a stock transaction service, an e-commerce service, an administrative service, or the like.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram of an authentication system using bar codes in accordance with an embodiment of the present invention;

FIG. 2 is a diagram illustrating an operation flow of an authentication method using bar codes in accordance with an embodiment of the present invention;

FIG. 3 is a diagram illustrating an example of implementing an operation illustrated in FIG. 2;

FIG. 4 is a diagram illustrating an operation flow of an authentication method using bar codes in accordance with another embodiment of the present invention;

FIG. 5 is a diagram illustrating an example of implementing an operation illustrated in FIG. 4;

FIG. 6 is a diagram illustrating an operation flow of an authentication method using bar codes in accordance with another embodiment of the present invention; and

FIG. 7 is a diagram illustrating an example of implementing an operation illustrated in FIG. 6.

### DESCRIPTION OF SPECIFIC EMBODIMENTS

Hereinafter, an authentication system and an authentication method using barcodes in accordance with embodiments of the present invention will be described with reference to the accompanying drawings. In describing an embodiment, a thickness of lines illustrated in the drawings, a size of components, etc., may be exaggeratedly illustrated for clearness and convenience of explanation. In addition, terms described to be below are terms defined in consideration of functions in the present invention, which may be changed according to the intention or practice of a user or an operator. Therefore, these terms will be defined based on contents throughout the specification.

A barcode is a code in which computer readable information is recorded. In recent years, research into a technology of recording information using at least two-dimensional barcode and transferring the recorded information has been actively conducted.

In particular, electronic devices such as a smart phone, or the like, which is rapidly distributed, fundamentally include a camera capable of receiving barcodes, and therefore, can transmit and receive information using the barcodes even when the separate communication network is not used.

Therefore, an embodiments of the present invention are to provide the authentication system and the authentication method capable of safely performing the authentication by storing a certificate or a signature key in personal terminal devices such as a smart phone, a mobile phone, or the like, and performing the authentication using the stored certificate or signature key so as to physically separate the certificate or the signature key from the terminal devices that receive services such as Internet banking, or the like.

Further, the barcodes disclosed in the specification may include a linear type of one-dimensional barcodes and a matrix-type of two-dimensional barcodes and three-dimensional barcodes. In particular, the two-dimensional barcode may include codes such as a quick response (QR) code, PDF417, DataMatric, Maxicode, or the like.

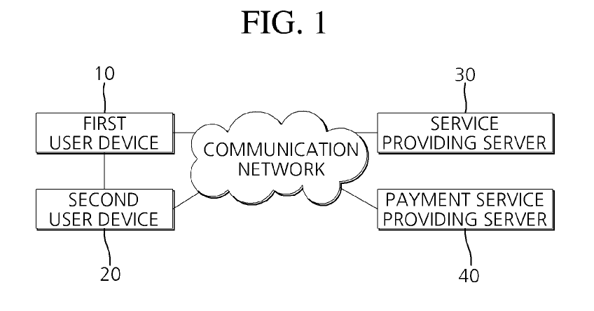

FIG. 1 is a block diagram of an authentication system using bar codes in accordance with an embodiment of the present invention.

As illustrated in FIG. 1, an authentication system using bar codes in accordance with an embodiment of the present invention is configured to include a first user device 10, a second user device 20, and a service providing server 30.

In this configuration, when services provided from the service providing server 30 are e-commerce involving purchases or settlements, the authentication system using the barcodes in accordance with an embodiment of the present invention may be configured to further include a payment service providing server 40.

The first user device 10 accesses the service providing server 30 that provides services such as Internet banking, stock transaction, e-commerce, administrative service, or the like, according to the input of the user.

The first user device 10 may access the Internet through wired and wireless communication networks such as a computer, a notebook, a net book, a tablet PC, or the like, and may be various electronic devices that can display specific information.

When the service providing server 30 provides services to be authenticated by the user, the first user device 10 receives authentication related information required for the user authentication from the service providing server 30, and converts into the barcodes and outputs the barcodes.

In this case, the authentication related information means the related information is required for the user authentication. For example, the authentication related information on Internet transfer services may include information such as a transfer bank, a transfer amount, an account holder's name, a remitter's name, or the like.

In addition, when services provided by the service providing server 30 are e-commerce, the first user device 10 may receive the purchase information on goods to be purchased from the service providing server 30 and convert into the barcodes and output the barcodes.

In this case, the purchase information may include the name, price, seller information, or the like, of goods.

Meanwhile, the first user device 10 includes a barcode generation module (not illustrated) that may just generate the barcodes, or may just generate the barcodes that include the authentication related information or the purchase information received by the barcode generation module (not illustrated) from the service providing server 30, together with the authentication related information or the purchase information.

In addition, the first user device 10 may include a barcode input module (not illustrated) such as a camera, a webcam, a barcode scanner, or the like, capable of receiving the barcodes output from the second user device 20 to be described below.

The second user device 20 receives the barcodes output from the first user device 10 and reads the received barcodes to output and display the authentication related information or the purchase information recorded in the barcodes.

The second user device 20 may preferably be personal terminal devices such as a smart phone, a mobile phone, PDA, or the like, and the second user device 20 may include the barcode input module (not illustrated) capable of receiving the barcode such as a camera, a barcode scanner, or the like.

Then, the second user device 20 generates the signature information or the authentication information on the authentication related information or the purchase information by using the signature key or the certificate of the user that is stored in the second user device 20, and provides the generated signature information or authentication information to the service providing server 30.

In this case, the second user device 20 may provide the aforementioned signature information or authentication information to the service providing server 30 through the first user device 10 and may be directly transmitted to the service providing server 30 through the separate communication network.

The detailed process of allowing the second user device 20 to provide the signature information or the authentication information to the service providing server 30 will be described below.

The service providing server 30 provides various services such as Internet banking, stock transaction, e-commerce, administrative service, or the like, according to the request of the first user device 10 that is accessed for receiving the services.

In this case, when the service providing server 30 performs the services to be authenticated by the user, the service providing server 30 provides the authentication related information required for the user authentication or the purchase information on the specific goods to the first user device 10 accessing the service providing server 30.

Thereafter, the service providing server 30 performs the authentication by using the signature information or the authentication information received from the first user device 10 or the second user device 20 and when the authentication is completed, after the services requested from the first user device 10 are performed, the service performance results are provided to the first user device 10 requesting the services.

When the services provided from the service providing server 30 are e-commerce involving the purchase or the settlement, the payment service providing server 40 receives, from the first user device 10 or the second device 20, the purchase information provided from the service providing server 30 and the signature information or the authentication information generated from the second user device 20 to perform the authentication and the settlement and when the authentication and the settlement are completed, provides the purchase complete information to the service providing server 30.

Meanwhile, the services provided from the service providing server 30 are not limited to the aforementioned examples, and the service providing server 30 may provide various services to be authenticated by the user.

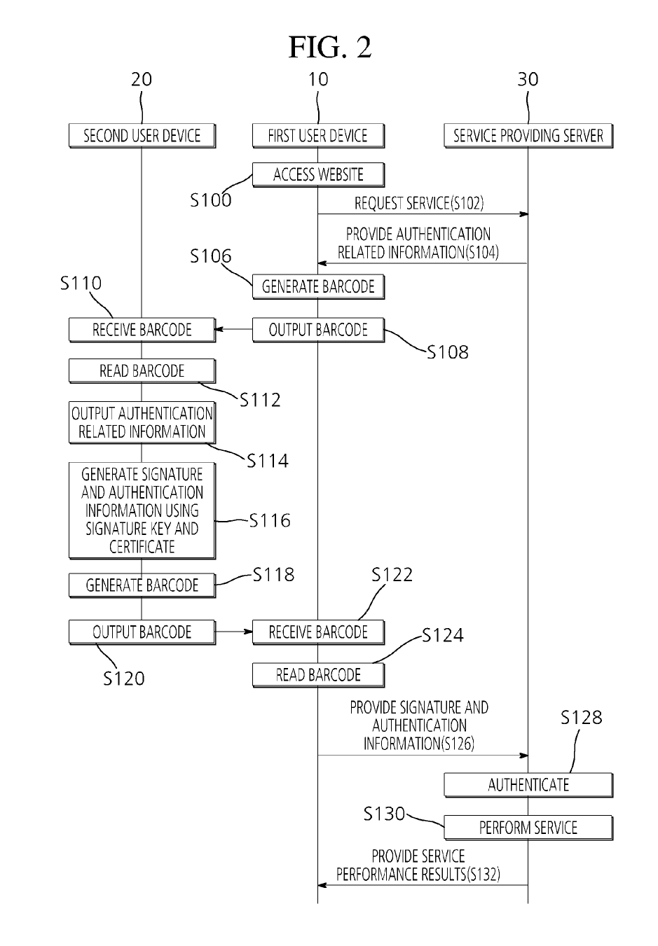

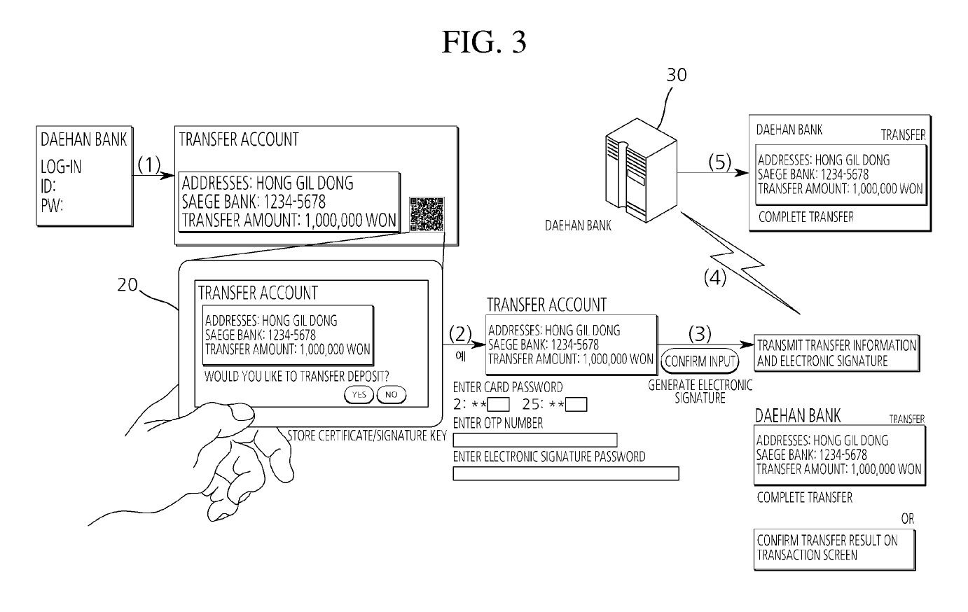

FIG. 2 is a diagram illustrating an operation flow of an authentication method using barcodes in accordance with an embodiment of the present invention and FIG. 3 is a diagram illustrating an example of implementing an operation illustrated in FIG. 2. Hereinafter, the detailed operation of an embodiment of the present invention will be described with reference to FIGS. 2 and 3.

First, the first user device 10 accesses a web site provided from the service providing server 30 according to the input of the user (S100) and requests the services provided to the service providing server 30 (S102).

When the user authentication is required for performing the services requested by the first user device 10, the service providing server 30 provides the authentication related information required for the user authentication to the first user device 10 (S104).

In this case, the service providing server 30 may provide the barcode generation module that may convert the authentication related information into the barcodes, together with the authentication related information.

Further, the service providing server 30 may provide information on session random number, timestamp information, card number, one-time password (OTP), or the like, for additional authentication.

Then, the first user device 10 uses the barcode generation module that is included therein or provided from the service providing server 30 to convert and generate the authentication related information into the barcode (S106) and outputs the generated barcodes and displays the generated barcodes on the screen (S108).

Then, the second user device 20 uses the barcode input module such as a camera, a barcode scanner, or the like, to receive the barcodes output from the first user device 10 (S110) and reads the received barcodes to extract the authentication related information recorded in the barcode (S112) and then, output the extracted authentication related information on the screen (S114).

Next, the user can confirm whether the authentication related information output to the second user device 20 is valid.

If it is determined that the authentication related information is valid, the second user device 20 uses the signature key or the certificate stored in the second user device 20 to generate the signature information or the authentication information (S116).

In this case, the second user device 20 may input the secret key information for generating the signature information or the authentication information from the user.

Thereafter, the second user device 20 uses the barcode generation module to convert the signature information or the authentication information into the barcodes (S118) and output the generated barcodes on the screen (S120).

Then, the first user device 10 uses the barcode input module such as a camera, a webcam, a barcode scanner, or the like, to receive the barcodes output from the second user device 20 (S122) and reads the received barcode to extract the signature information or the authentication information recorded in the barcode (S124) and then, provides the extracted authentication information or the authentication information to the service providing server 30 (S126).

The service providing server 30 verifies the validity of the signature information or the authentication information provided from the first user device 10 to perform the authentication (S128) and when the authentication is completed, performs the requested service (S130) and then, provides the service performance results to the first user device 10 (S132).

During the process, the service providing server 30 may additionally verify the validity of the session random number, the timestamp information, the card number, or the one-time password that are first provided.

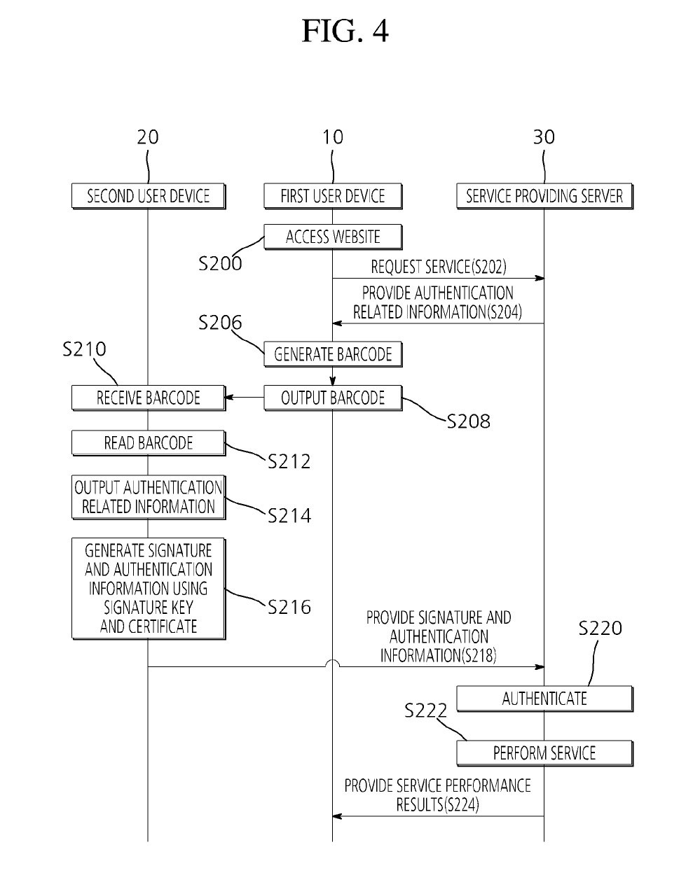

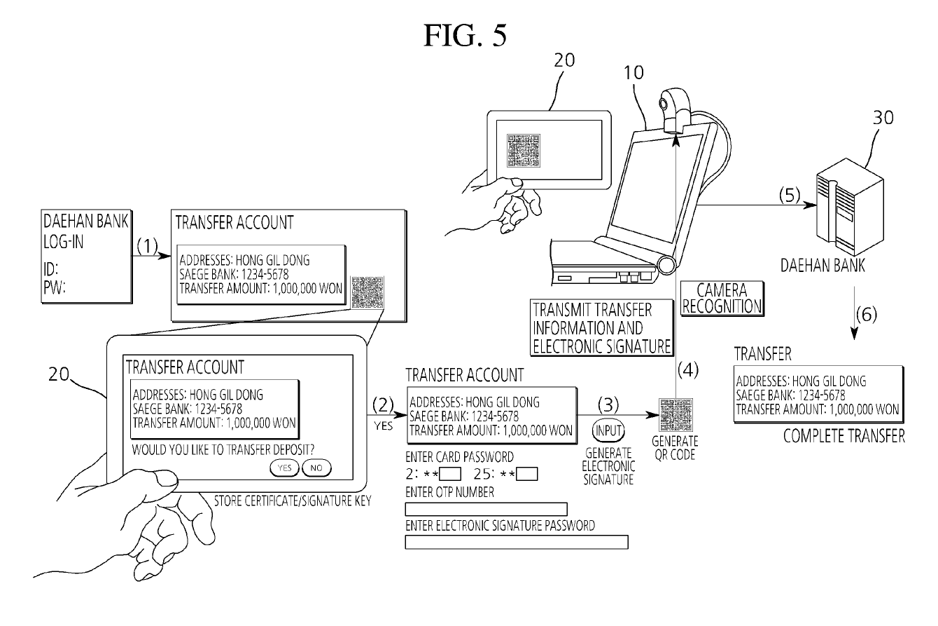

FIG. 4 is a diagram illustrating an operation flow of an authentication method using barcodes in accordance with another embodiment of the present invention and FIG. 5 is a diagram illustrating an example of implementing an operation illustrated in FIG. 4.

In the aforementioned embodiments, the second user device 20 uses the signature key or the certificate to transmit the generated signature information or the authentication information to the first user device 10 through the barcode and the first user device 10 provides the signature information or the authentication information to the service providing server 30.

That is, the second user device 20 provides the signature information or the authentication information to the service providing server 30 through the first user device 10.

However, when the second user device 20 may access the Internet through a mobile communication network or other wireless communication networks, the second user device 20 may directly provide the signature information or the authentication information to the service providing server 30 through the separate communication network.

Hereinafter, the difference between the authentication method using the barcodes in accordance with another embodiment of the present invention and the aforementioned embodiments will be mainly described with reference to FIGS. 4 and 5.

S200 to S216 in which the first user device 10 receives the authentication related information from the service providing server 30 and outputs the received authentication related information as the barcodes and the second user device 20 receives the barcodes output from the first user device 10 and uses the signature key and the certificate to generate the signature information or the authentication information are the same as S100 to S116 of an embodiment as described above and therefore, the detailed description thereof will be omitted.

Thereafter, the second user device 20 directly provides the generated signature information or authentication information to the service providing server 30 through the communication network (S218).

In detail, the second user device 20 may provide the signature information or the authentication information to the service providing server 30 through a mobile communication network or other various communication networks such as Wi-Fi, WiBro, WiMax, Zigbee, Bluetooth, or the like and the communication network used in the second user device 20 may be a separate communication network that is different from a communication network between the first user device 10 and the service providing server 30.

In addition, the second user device 20 may previously include information such as address, or the like, that may access the service providing server 30 or may be provided with the information from the first user device 10.

Then, the service providing server 30 verifies the validity of the signature information or the authentication information provided from the second user device 10 to perform the authentication (S220) and when the authentication is completed, performs the requested service (S222) and then, provides the service performance results to the first user device 10 (S224).

Similar to the aforementioned embodiments, the service providing server 30 may additionally verify the validity of the session random number, the timestamp information, the card number, or the one-time password that are first provided.

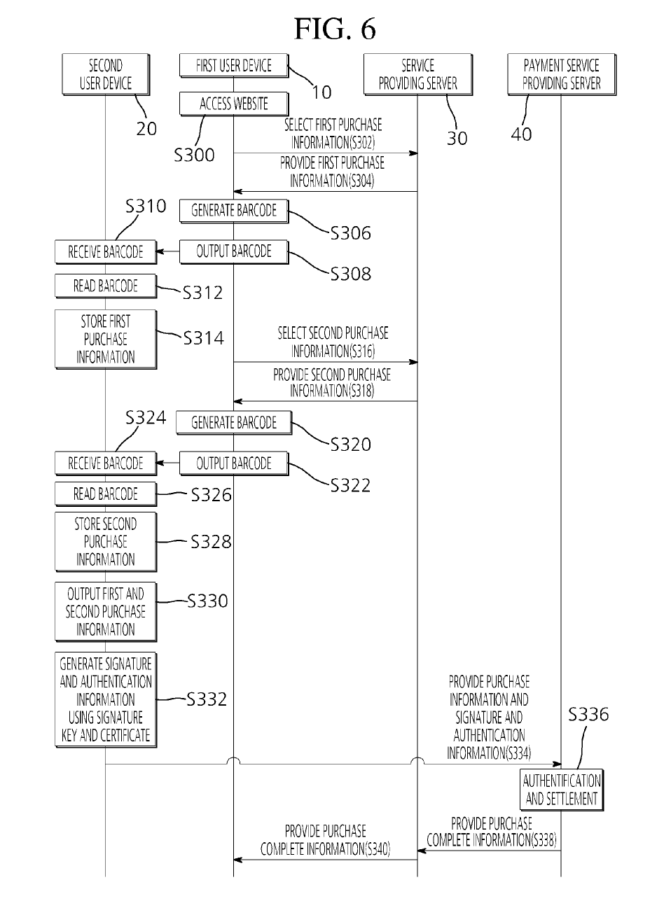

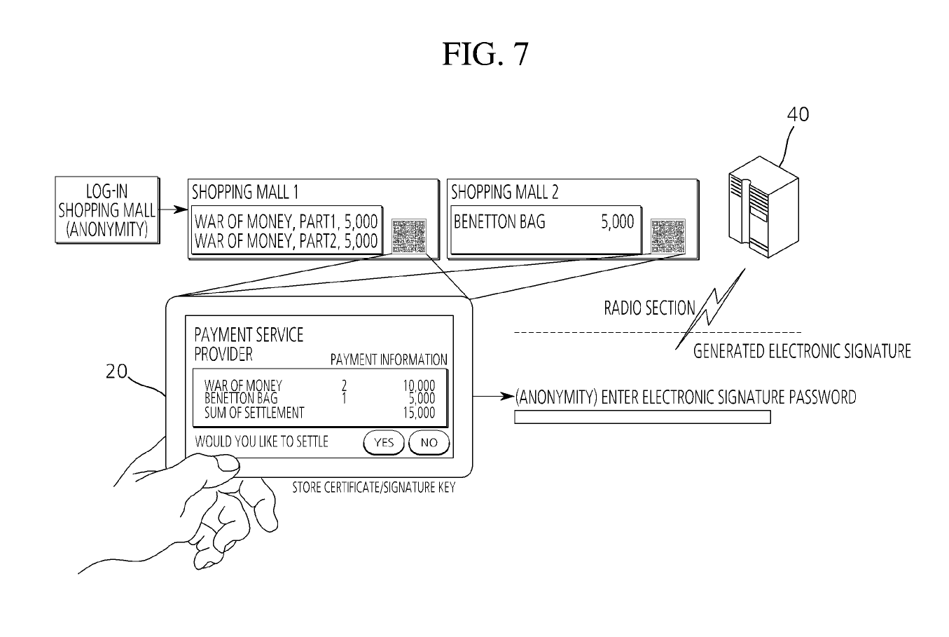

FIG. 6 is a diagram illustrating an operation flow of an authentication method using barcodes in accordance with another embodiment of the present invention and FIG. 7 is a diagram illustrating an example of implementing an operation illustrated in FIG. 6.

The aforementioned two embodiments describe the case in which the payment service providing server 40 is not provided. That is, the aforementioned two embodiments may be applied to the case in which the services to be authenticated by the user in the Internet banking, the stock transaction, the administrative service, or the like, not involving the purchase or the settlement, are provided.

However, when the services provided from the service providing server 30 are e-commerce involving the purchase or the settlement, the authentication system in accordance with an embodiment of the present invention may be configured to further include a payment service providing server 40 for providing the payment services.

In this case, the service providing server 30 may provide the purchase information on the goods such as the Internet shopping mall and the payment service providing server 40 may provide the payment service when the goods are purchased.

Hereinafter, an authentication method in accordance with another embodiment of the present invention will be described in detail with reference to FIGS. 6 and 7.

First, the first user device 10 access the website provided from the service providing server 30 according to the input of the user (S300) and requests the first purchase information selected by the user in the purchase information list provided from the service providing server 30 to the service providing server 30 (S302).

Then, the service providing server 30 provides the first purchase information to the first user device 10.

In this case, the service providing server 30 may provide the barcode generation module that may convert the first purchase information into the barcodes, together with the first purchase information.

Then, the first user device 10 uses the barcode generation module that is included therein or provided from the service providing server 30 to convert and generate the first purchase information into the barcodes (S306) and outputs the generated barcodes and display the generated barcodes on the screen (S308).

Then, the second user device 20 uses the barcode input module such as a camera, a barcode scanner, or the like, to receive the barcodes output from the first user device 10 (S310) and reads the received barcodes to extract the first purchase information recorded in the barcode (S312) and then, store the extracted first purchase information (S314).

When the additional purchase is performed, the first user device 10 additionally selects and requests the second purchase information in the purchase information list provided from the service providing server 30 (S316).

The service providing server 30 provides the second purchase information to the first user device 10 (S318) and the first user device 10 uses the barcode generation module that is included therein or provided from the service providing server 30 to convert and generate the second purchase information into the barcode (S320) and outputs the generated barcodes and displays the generated barcodes on the screen (S322).

Then, the second user device 20 uses the barcode input module such as a camera, a barcode scanner, or the like, to receive the barcodes output from the first user device 10 (S324) and reads the received barcodes to extract the second purchase information recorded in the barcode (S326) and then, store the extracted second purchase information (S328).

Then, when the collection of the additional purchase information is not performed, the second user device 20 outputs and displays the stored first and second purchase information (S330) and when the validity of the first and second purchase information is confirmed, uses the stored signature key or certificate of the user to generate the signature information or the authentication information (S332).

In this case, the second user device 20 may receive the secret key information for generating the signature information or the authentication information from the user, wherein the signature information or the authentication information may be generated for a part or all of the plurality of purchase information stored in the second user device 20.

Thereafter, the second user device 20 provides the generated signature information or authentication information to the payment service providing server 40 through the separate communication network, together with the purchase information (S334).

In this case, the method for allowing the second user device 20 to provide the information to the payment service providing server 40 through the separate communication network is the same as the method for providing information to the aforementioned service providing server 30 and the detailed description thereof will be omitted.

In addition, the second user device 20 may provide the information to the payment service providing server 40 through the first user device 10 as described above.

Then, the payment service providing server 30 verifies the validity of the signature information or the authentication information provided from the second user device 20 and verifies the validity of the purchase information to perform the authentication and when the authentication is completed, performs the settlement (S336).

Then, the payment service providing server 30 provides the purchase completion information to the service providing server 30 (S338) and the service providing server 30 provides the purchase completion information to the first user device 10 (S340).

Meanwhile, an embodiment of the present invention describes, by way of example, the case in which the e-commerce service is performed by receiving the purchase information on two goods from the service providing server 30 of the same subject.

However, unlike the case, an embodiment of the present invention may be applied even when the plurality of goods is purchased from the service providing server 30 of different subjects.

That is, the user uses the first and second user devices 10 and 20 to receive the purchase information on the plurality of goods from the service providing server 30 of different subjects and stores the received purchase information in the second user device and then, generates the signature information and the authentication information on the stored purchase information and provides the generated signature information and authentication information to the payment service providing server 40 to simultaneously perform the authentication and the settlement.

Meanwhile, an embodiment of the present invention describes, by way of example, the case in which the information exchange is performed between the first user device 10 and the second user device 20 by using the barcodes, but is not limited thereto and may also use the pattern image capable of recording the information.

In accordance with the authentication system and the authentication method using the barcodes of an embodiments of the present invention, when the services to be authenticated by the user are performed, the signature information or the authentication information of the user may be generated in the personal terminal device such as the smart phone, the mobile phone, or the like, and thus, the security for the signature key or the certificate may be enhanced.

Further, the exemplary embodiments of the present invention can allow the user to conveniently receive the services to be authorized by the user anytime and anywhere since the certificate or the secrete key of the user is stored in personal terminal devices always carried by the user.

In addition, an embodiments of the present invention can perform the authentication via the barcodes. In recent years, most of personal terminal devices include the camera capable of receiving the barcodes not to cause the separately additional costs.

Finally, the exemplary embodiments of the present invention can safely perform the authentication through the separate communication network even when the devices capable of receiving the bar codes are not included in computer, notebook, or the like, since personal terminal devices such as a smart phone, or the like, capable of transmitting data through a separate communication network.

When storing the certificates in a hard disk of a computer or USB memory, it is vulnerable to the security threats such as computer hacking or virus. According to the present invention, security can be enhanced through a physically separated key and certificate service domain. Thus, users can use the authentication service using electronic signature safely in the public places like a PC room.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. An authentication method using barcodes, comprising:
converting into a first barcode and outputting, by a first user device, authentication related information provided from a service providing server;
receiving, by a second user device, the first barcode;
generating, by the second user device, signature information or authentication information on the authentication related information by using a signature key or a certificate; and
providing, by the second user device, the signature information or the authentication information to the service providing server.

2. The authentication method of claim 1, wherein at the providing of the signature information or the authentication to the service providing server, the second user device provides the signature information or the authentication information to the service providing server through the first user device.

3. The authentication method of claim 2, wherein the providing of the signature information or the authentication information to the service providing server includes:
converting into a second barcode and outputting, by the second user device, the signature information or the authentication information;
receiving, by the first user device, the second barcode for the signature information or the authentication information; and
transmitting, by the first user device, the signature information or the authentication information to the service providing server.

4. The authentication method of claim 1, wherein at the providing of the signature information or the authentication information to the service providing server, the second user device may transmit the signature information or the authentication information to the service providing server through a wireless communication network.

5. An authentication method using barcodes, comprising:
receiving, by a first user device, at least one purchase information selected by a user in a purchase information list from a service providing server, and converting into at least one barcode and outputting the at least one purchase information;
receiving, by a second user device, the at least one barcode to receive the at least one purchase information;
generating, by the second user device, signature information or authentication information on the at least one purchase information by using a signature key or a certificate; and
providing, by the second user device, the signature information or the authentication information to a payment service providing server for providing a payment service.

6. The authentication method of claim 5, wherein at the generating of the signature information or the authentication information, if one or a plurality of purchase information is sent from the first user device, the second user device generates the signature information or the authentication information for a part or all of the plurality of purchase information.

7. The authentication method of claim 6, wherein the plurality of purchase information is provided from a plurality of different service providing servers.

8. The authentication method of claim 5, wherein at the providing of the signature information or the authentication information to the payment service providing server, the second user device provides the signature information or the authentication information to the payment service providing server through the first user device.

9. The authentication method of claim 5, wherein the providing of the signature information or the authentication information to the payment service providing server includes:
converting into a second barcode and outputting, by the second user device, the signature information or the authentication information;
receiving, by the first user device, the second barcode for the signature information or the authentication information; and
transmitting, by the first user device, the signature information or the authentication information to the payment service providing server.

10. An authentication system using barcodes, comprising:
a service providing server configured to provide service to be authenticated by a user;
a first user device configured to convert into the barcodes and output information provided from the service providing server; and
a second user device configured to receive the barcodes output from the first user device, generate signature information or authentication information by using a signature key or a certification, and provide the signature information or the authentication information to the service providing server.

11. The authentication system of claim 9, further comprising a payment service providing server configured to receive the signature information or the authentication information from the second user device to provide a payment service for the service provided from the service providing server.

12. The authentication system of claim 9, wherein the service provided from the service providing server is any one of an Internet banking service, a stock transaction service, an e-commerce service, and an administrative service.
